(19) United States
(12) Patent Application Publication
(10) Pub. No.: US 2018/0281076 A1
(43) Pub. Date: Oct. 4, 2018

(54) GELLING REDUCTION TOOL FOR GROOVING CHEMICAL MECHANICAL PLANARIZATION POLISHING PADS

(71) Applicant: Rohm and Haas Electronic Materials CMP Holdings, Inc., Newark, DE (US)

(72) Inventors: Patrick S. Delaney, Wilmington, DE (US); Jeffrey Robert Stack, Clayton, DE (US); Brian T. Cantrell, Port Deposit, MD (US)

(21) Appl. No.: 15/476,286

(22) Filed: Mar. 31, 2017

(51) Int. Cl. B23B 27/06; B23B 27/00

(52) U.S. Cl. CPC B23B 27/06; B23B 27/005; B24B 37/26; B23B 2226/61; B23B 2220/12

(57) ABSTRACT

The present invention provides a grooving tool for machining the surface of a polymeric foam article, such as a chemical mechanical (CMP) polishing pad, the grooving tool comprising a flat bed platen on which the article sits, a grooving tool frame having a front face positioned parallel to and facing the flat surface of the polymeric foam article on which front face is contained one or more cutting tool teeth arranged in a predetermined direction and with a constant pitch. Each cutting tool tooth has a non-cutting shoulder where it joins the grooving tool frame (i) a groove cutting face that forms a rake angle ranging from 2° to 80°, (ii) a chip ejection face located on the top of the tooth between the non-cutting shoulder and the groove cutting face and (iv) a shouldering radius transitioning from the cutting tool tooth to the non-cutting shoulder.

The present invention relates to an improved grooving tool for cutting circumferential grooves into a polymeric foam article, such as a chemical mechanical planarization (CMP) polishing pad, as well as top methods of using the grooving tool.

Chemical mechanical planarization, or chemical mechanical planarization (CMP) polishing, is a common technique used to planarize or polish work pieces such as semiconductor wafers, and optical or memory substrates. In conventional CMP, a wafer carrier or polishing head, is mounted on a carrier assembly. The polishing head holds the wafer and positions the wafer in contact with a polishing layer of a polishing pad that is mounted on a table or platen within a CMP apparatus. The carrier assembly provides a controllable pressure between the wafer and polishing pad. Simultaneously, a polishing medium (e.g., a slurry) is dispensed onto the polishing pad and is drawn into the gap between the wafer and polishing layer. To effect polishing, the polishing pad and wafer typically rotate relative to one another. The wafer surface is polished and made planar by chemical and mechanical action of the polishing layer and polishing medium on the surface. In such CMP polishing, the slurry and the polishing pad act together to planarize the substrate surface. It is critical that both the slurry and polishing pad remain in contact with the substrate at the same time. However, if excessive amounts of slurry pool on top of the polishing pad, the substrate will hydroplane on the polishing pad surface and the polishing pad will not effectively planarize the substrate. Further, scratches and other defects will likely result if the debris generated from CMP polishing build up on the polishing pad or substrate surface during polishing. Accordingly, CMP polishing pads contain grooves. Such grooves also ensure that the slurry is uniformly distributed across the pad surface.

Grooves in CMP polishing pads may be formed via a number of ways including machining, embossing, and molding against a male groove forming surface. Of these methods, machining the CMP polishing pads is the most effective way to form grooves because an effective molding method for making useful polishing pads has not yet been devised. When machining grooves in CMP polishing pads, gelling defects can result wherein removed pad debris melts and adheres to the pad surface or groove edges remains the most common problem. Any detectable gelling defect means that a polishing pad containing it must be discarded. In fact, gelling defects represent a large scrap cost to CMP pad manufacturers.

Japanese patent publication no. JP2002184730A to Toho Engineering discloses a CMP polishing pad groove cutting tool for use in cutting grooves in a hard urethane foam CMP polishing pad. The cutting edge of the tool is shaped so that corners of the grooves in the resulting grooved pad remain sharp and retain their shape in use. The cutting edge has a tool angle of 10° to 20° from a line that is normal to the pad, has a back clearance angle of 45° to 55°, and a side clearance angle of 0° to 2° because its side could bear against the peripheral wall of the groove during cutting. However, even if the tool of Toho Engineering might cut grooves in the resulting CMP polishing pads which remain effective over time, it still does little to prevent gelling defects in making grooved CMP polishing pads.

The present inventor has endeavored to reduce the problem of gelling defects caused in machining CMP polishing pads to form grooves therein.

### STATEMENT OF THE INVENTION

1. In accordance with the present invention, a grooving tool for machining the surface of a polymeric foam article, preferably, a polyurethane foam article having both a top and a bottom with a flat surface of a radius X, such as a chemical mechanical planarization (CMP) polishing pad, to form grooves therein, the grooving tool comprising: a flat bed platen having a bed with a radius Y larger than radius X, the flat bed platen mounted rotatably on or to a static base, such as a table or a metal framework, preferably, mounted to rotate counterclockwise, about an axis A which is perpendicular to the bed and connected to a drive mechanism which rotates the flat bed platen; and a grooving tool frame mounted on an arm (a) connected to a drive mechanism, such as a gear connection, which rotates the grooving tool frame about axis A reciprocally to the rotation of the flat bed platen or, (b) preferably, mounted on or connected to a static base, such as a table or metal framework, the grooving tool frame having a front face positioned parallel to and facing the flat surface of the polymeric foam article or polishing pad on which front face is contained along an axis B which runs parallel to any radius X of the polymeric foam article or polishing pad one or more, or, preferably, from 8 to 62 or, more preferably, from 16 to 32 cutting tool teeth arranged in a predetermined direction and with a constant pitch so that the angle between each cutting tool tooth and the flat surface of the article or pad remains constant from tooth to tooth, wherein each cutting tool tooth has a non-cutting shoulder where it joins the grooving tool frame and has (i) a groove cutting face on the top of the tooth having a front edge, which can be any shape, such as rounded or square, two side edges and a flat portion extending between the two side edges and having a constant width (W), and each cutting tool tooth is positioned so that the flat portion of the groove cutting face forms a rake angle with a line segment that is normal to the flat surface of the polymeric foam article or polishing pad, the rake angle ranging from 2° to 80° or, preferably, from 7° to 20°, or, more preferably, from 8° to 16°, (ii) a chip ejection face located on the top of the tooth between the non-cutting shoulder and the groove cutting face having a constant width (W) and forming an obtuse chip ejection angle ranging from 100° to 170° or, preferably, from 120° to 160° with the groove cutting face, (iii) a tool tooth bottom face; (iv) a shouldering radius transitioning from the cutting tool tooth to the non-cutting shoulder and extending from the top of the tooth at the chip ejection face to the tool tooth bottom face.

2. The grooving tool of the present invention as set forth in item 1, above, wherein the one or more cutting tool teeth are arranged so that the (i) groove cutting face would be normal to the flat surface of the pad or article when subtracting the rake angle from the angle formed by the flat surface of the pad or article and the groove cutting face.

3. The grooving tool of the present invention as set forth in any one of items 1 or 2, above, wherein in any cutting tool tooth the width ratio of the non-cutting shoulder to the width (W) of the flat portion of the groove cutting face of the cutting tool tooth ranges from 1.1:1 to 3:1 or, preferably, from 1.4:1 to 2.5:1.

4. The grooving tool of the present invention as set forth in any one of items 1, 2, or 3, above, wherein the (iii) tool tooth bottom face is narrower than the width (W) of the groove cutting face and the chip ejection face and the tool tooth has on each side a side face such that a side relief angle is formed by the plane of each side face and a line segment that runs normal to the groove cutting face starting at the side edge of the groove cutting face.

5. The grooving tool of the present invention as set forth in item 4, above, wherein the side faces of the cutting tool tooth form a side relief angle or taper, from the top to the bottom of the cutting tool tooth of from 1° to 15° or, preferably, from 2° to 10° or, preferably, from 2° to 7°, for example, 2°, on the right hand side of the tooth, and from 5 to 10°, for example, 7°, on left hand side of the tooth.

6. The grooving tool of the present invention as set forth in any one of items 1, 2, 3, 4, or 5, above, wherein the grooving tool frame further comprises for each cutting tool tooth a protrusion radius extending from the front face of the grooving tool frame to the non-cutting shoulder of the cutting tool tooth.

7. The grooving tool of the present invention as set forth in any one of items 1, 2, 3, 4, 5 or 6, above, wherein each of the one or more cutting tool teeth comprises (v) a relief face extending from the (i) front edge of the groove cutting face to the (iii) tool tooth bottom, thereby forming a bottom relief angle between the relief face and the groove cutting face and defined by the plane of the top groove cutting face and the plane of the relief face.

8. The grooving tool of the present invention as set forth in item 7, above, wherein the bottom relief angle ranges from 5° to 30° or, preferably, from 15° to 25°.

9. The grooving tool of the present invention as set forth in any one of items 1, 2, 3, 4, 5, 6, 7, or 8, above, wherein each cutting tool tooth and non-cutting shoulder comprise a metal or semi-metal carbide, such as tungsten carbide or an alloy thereof, such as an alloy with cobalt, for example, one containing from 8 to 15 wt. %, or, preferably, from 10 to 13 wt. % of cobalt.

10. The grooving tool of the present invention as set forth in items 9, above, wherein each cutting tool tooth is coated with a metal nitride, such as, for example, TiAIN.

11. The grooving tool of the present invention as set forth in any of items 1, 2, 3, 4, 5, 6, 7, 8, 9, or 10, above, wherein, preferably, the flat bed platen is disposed vertically, or parallel with gravitational force, and comprises a vacuum platen to hold the polymeric foam article or CMP polishing pad in place.

12. The grooving tool of the present invention as set forth in any of items 1, 2, 3, 4, 5, 6, 7, 8, 9, 10, or 11 above, wherein, preferably, the grooving tool comprises more than one cutting tool tooth and the cutting tool teeth are arranged an equal distance apart from each other according to the groove pitch desired.

In accordance with another aspect of the present invention methods of making grooved polymeric foam articles having a flat surface, such as CMP polishing pads made of a polymeric foam, preferably, polyurethane, comprise (a) placing the flat surface of the polymeric foam article or CMP polishing pad on a flat bed platen and adhering it thereto preferably, by vacuum, (b) positioning a grooving tool frame so that the front face of the grooving tool faces the flat surface of the polymeric foam article or polishing pad adhered to the flat bed platen, with each of the flat surface of the polymeric foam article or polishing pad and the flat bed platen having a center point so as to align each of the center points along axis A which is perpendicular to the flat surface of the polymeric foam article or polishing pad and to the flat bed platen, (c) rotating the grooving tool frame and/or the flat bed platen having the article or pad adhered thereto relative to each other about axis A so that the flat surface of the polymeric foam article or polishing pad strikes the groove cutting face of the one or more cutting tool teeth with the grooving tool frame and the flat bed platen rotating reciprocally to one another or, preferably, rotating just the flat bed platen, or, more preferably, rotating just the flat bed platen counterclockwise, while moving the grooving tool frame toward the flat surface of the polymeric foam article or polishing pad, preferably laterally into the flat surface wherein axis A extends normally through the center of the radius of curvature of any path transcribed by the grooving tool frame if it rotates, so as to cut circumferential grooves into the flat surface of the polymeric foam article or polishing pad.

In the methods of the present invention, for example, the radially inner most one of the circumferential grooves cut into the polymeric foam article or polishing pad has a radius of curvature of 10 mm or smaller.

Preferably, in the methods of the present invention the flat bed platen is rotated counterclockwise and the grooving tool is held stationary.

The method of the present invention preferably further comprises: (d) simultaneously cutting a multiplicity of circumferential, annular or concentric grooves into the flat surface of the polymeric foam article or polishing pad. This may be done so that, for example, the radially innermost one of the multiplicity of circumferential, or concentric annular grooves has a radius of curvature of 10 mm or smaller.

The methods of the present invention may be carried out using the grooving tool as set forth in any one of items 1 to 12, above.

Preferably, the methods of the present invention are carried out on hard pads having a Shore D hardness of from 60 to 90 or, preferably, from 65 to 90. In the forming of grooves in harder CMP polishing pads having the Shore D hardness of 60 to 90, a continuous chip forms which is long, and it must not only be ejected from the pad surface but it also must be broken or removed from the vicinity of the pad surface. The chip ejection face of the grooving tool of the present invention enables such breaking or removal of a continuous chip from the vicinity of a CMP polishing pad surface during groove formation.

More preferably, the methods comprise cutting one or more grooves in a polymeric foam article wherein the grooving tool makes multiple progressive plunges to a final depth, wherein after each plunge, the method comprises retracting the grooving tool above the article or groove surface. Such a method is called “chip breaking” because the retraction above the article groove surface “breaks” the chip and clears it away from the grooving tool surface before once again plunging into the pad. For example, to make a 0.030″ deep groove, the method comprises plunging the cutting tool tooth in to a 0.01″ depth, followed by retracting the cutting tool tooth completely out of the groove above the article surface, plunging the cutting tool tooth back into the article to a depth of 0.02″ and retracting out of the groove above the article surface before finally plunging it back into a final depth of 0.03″ and retracting it to break the debris chip; finally, plunging the cutting tool tooth to 0.03″ depth as a cleanup pass finalizes the groove shape and clear any remaining debris.

As used herein, the term “annular or concentric grooves” denotes grooves extending in a circumferential direction of the polishing pad, e.g., a multiplicity of annular or concentric grooves, or a spiral groove or grooves.

As used herein, the term “ASTM” refers to publications of ASTM International, West Conshohocken, Pa.

As used herein, the term “circumferential grooves” denotes grooves that extend around the center point of the flat surface of the polishing pad or polymeric foam article.

As used herein, the term “Shore D hardness” is the hardness of a given material as measured according to ASTM D2240-15 (2015), “Standard Test Method for Rubber Property—Durometer Hardness”. Hardness was measured on a Rex Hybrid hardness tester (Rex Gauge Company, Inc., Buffalo Grove, Ill.), equipped with a D probe. Six samples were stacked and shuffled for each hardness measurement.

As used herein, unless otherwise indicated, the term “wt. % NCO” refers to the amount as reported on a spec sheet or MSDS for a given NCO group or blocked NCO group containing product.

As used herein, the term “wt. %” stands for weight percent.

### BRIEF DESCRIPTION OF THE DRAWINGS

FIG. 1 depicts an isometric projection of a grooving tool frame (10) in accordance with the present invention including multiple cutting tool teeth (14) protruding from the front face of the insert where it meets the surface of the polymeric foam article.

FIG. 2 depicts a detailed isometric projection of cutting tool teeth and their juncture with the lathe grooving insert in accordance with the present invention.

FIG. 3 depicts a side view of an individual cutting tool tooth (14, FIG. 1) in accordance with the present invention.

FIG. 3a depicts a side view of an individual cutting tool tooth (14, FIG. 1) in accordance with the present invention as well as the rake angle (Ø2), chip ejection angle (Ø1), and bottom relief angle (Ø3) of the cutting tool tooth.

FIG. 4 depicts an isometric projection of an individual cutting tool tooth (14, FIG. 1) in accordance with the present invention.

FIG. 5 depicts a top view of an individual cutting tool tooth in accordance with the present invention.

FIG. 6 depicts a frontal view of an individual cutting tool tooth as well as the side relief angle given by (Ø4).

The grooving tool of the present invention enables one to remove debris from the cutting face of the tool and limits gelling defects in the formation of grooves in CMP polishing pads. The grooving tool comprises a grooving tool frame with a front face having statically attached thereto one or more cutting tool teeth that provides more cleanly cut and dimensionally accurate grooves in urethane foam CMP polishing pads so as to produce a cleaner and more consistent groove shape while reducing the buildup of debris formed during the grooving of the polishing pads. The grooving tool of the present invention enables a reduction in detectable gelling defects, thereby enabling a polishing pad output yield of over 99% of all pads subject to grooving.

In use, the grooving tool frame is disposed with its front face parallel to and facing the flat surface of the polymeric foam article or polishing pad with the cutting tool teeth arranged so that their groove cutting face would be normal to the surface of the pad or article when subtracting the rake angle. Thus, for example, if each cutting tool tooth has a rake angle of 8°, the grooving tool frame is arranged so that the groove cutting faces of the cutting tool teeth form an angle of 98° with the flat surface of the pad or article. The grooving tool frame is then slowly moved towards the flat surface of the polymeric foam article to penetrate into the polymeric foam article to the desired depth of the grooves being formed thereby.

The cutting tool tooth of the present invention can form grooves of any shape, such as square and round bottom shaped grooves and is comprised of materials of increased rigidity and strength. The shape of the edge of the groove cutting face of the cutting tool tooth determines the bottom shape of the groove formed by the tool of the present invention.

The cutting tool tooth mounted on the grooving tool frame of the present invention has a rake angle of from 2° to 80° or, preferably, from 10° to 20°, or, preferably, from 8° to 16°, thereby providing a sharper cutting edge, and an inclined plane face in the cutting tool tooth to allow the grooving debris or grooving chip to more effectively curl away from the pad surface during grove formation. Preferably, the rake angle ranges from 8° to 16°. If the rake angle is set to 35 degrees or larger, the cutting tool tooth may cut undesirably into the inside of the polishing pad. On the other hand, if the rake angle is set to 4 degrees or smaller, the cutting ability of the grooving tool deteriorates in use.

The rake angle and the chip ejection angle can be tailored to optimize the performance the cutting tool of the present invention. A larger rake angle provides a sharper cutting tip and reduced stress input into the material to be grooved. However, a larger rake angle also decreases the overall strength of the tooth, and increases the rate of wear or dulling of the tooth. A greater chip ejection angle is also more desirable, but results in a reduction in strength of the tooth as well as an increase in tooth machining difficulty.

The cutting tool tooth of the present invention comprises a chip ejection face located on top of the tooth at the end of the groove cutting face nearest the shouldering of the cutting tool tooth and that is disposed at a chip ejection angle which allows the groove debris to exit the top cutting face of the tool with a smooth travel path leading away from the polishing pad surface. The chip ejection face of the cutting tool tooth of the present invention solves the gelling defect problem by eliminating the debris buildup on the tool cutting edge, which in turns causes excessive friction and heat leading to gelling of the urethane material. In contrast, a cutting tool tooth with a flat tooling face and a single tool tooth width without any relief angle results in the gelling defects and variable groove output parameters.

The cutting tool tooth of the present invention has a wider shoulder section or non-cutting shoulder such that rigidity is added to the base of the cutting tool tooth. Such rigidity strengthens the tooth to prevent harmonic and vibrational oscillation during the grooving process, thereby reducing the likelihood of tooth breakage.

The width ratio of the non-cutting shoulder to that of the cutting tool tooth could range in any value barring physical limitations and may preferably be, for example, 2:1.

In the methods of the present invention, cutting into a polymeric foam article or polishing pad forms circumferential, annular or concentric grooves having a width of 1.0 mm or smaller, with high dimensional accuracy and without occurrence of gelling defects or burrs in the walls of the grooves or on the polishing pad surface. Namely, the grooving tool of the present invention makes it possible to stably cut the grooves into the surface of the polishing pad, and to accurately form the desired grooves in the very inner circumferential portion of the circular work piece. The cutting tool tooth of the present invention has a side relief angle ranging from 1° to 15° or, preferably, from 2° to 10° or, preferably, from 2° to 7°, measured as the angle between the actual cutting tool tooth side wall and a side wall that is disposed perpendicular to the top groove cutting face of the cutting tool tooth. This arrangement enables the cutting tool tooth to avoid interface between the radially outer wall of each groove and the cutting tool tooth, thus making it possible to form grooves with dimensionally accurate side walls, even if a radius of curvature of the groove is relatively small. Actual values of the side relief angle may be suitably determined within the above-indicated range, taking into account the hardness or other specific physical properties of the polymeric foam article, and the value of the bottom relief angle of the tool, so that the cutting tool tooth is less likely to interface or cut into the radially outer wall of each groove. If either side relief angle exceeds 15°, durability or processability of the cutting tool tooth may be deteriorated. On the other hand, the right side relief angle of the cutting tool tooth with respect to a radially inner wall of each of the grooves can be set at around 1 to 4° because the interference between the cutting part of the turning tool and the radially inner wall of the each groove closest the center of the CMP polishing pad or polymeric foam article is less likely to occur.

Preferably, each cutting tool tooth width in the grooving tool of the present invention ranges from of 0.23 to 0.59 mm.

Preferably, the grooving tool of the present invention includes a plurality of cutting tool teeth which are arranged in a predetermined direction with a pitch within a range of 1.5 to 3.1 mm. This makes it possible to cut a plurality of generally concentric grooves with a width within a range of 0.005 to 1.0 mm and with a radial pitch of 1.5 to 3.1 mm with high efficiency.

In the front face of the grooving tool frame, the cutting tool teeth are arranged in a predetermined direction, with a generally constant pitch so that the angle between the cutting tool teeth and the flat surface of the pad or article remains constant from tooth to tooth.

Preferably, the grooving tool frame comprises multiple cutting tool teeth arranged an equal distance apart from each other according to the groove pitch desired.

In use, the grooving tool frame is disposed with its front face parallel to and facing the flat surface of the polymeric foam article or polishing pad with the cutting tool teeth arranged so that their groove cutting face would be normal to the surface of the pad or article when subtracting the rake angle. Thus, for example, if each cutting tool tooth has a rake angle of 8°, the grooving tool frame is arranged so that the groove cutting faces of the cutting tool teeth form an angle of 98° with the flat surface of the pad or article. While the flat bed platen, for example, rotates, the grooving tool frame is then slowly moved towards the flat surface of the polymeric foam article to penetrate into the polymeric foam article to the desired depth of the grooves being formed thereby.

In accordance with the of the present invention, the grooves formed by the cutting tool tooth can go all the way in to end of groove cutting face of the cutting tooth otherwise, the debris from the grooves may not be ejected from the article or pad surface; and, if the grooves are deep enough that the cutting tool tooth penetrates to the non-cutting shoulder, the resulting grooves will be too wide and have irregular sidewalls

Preferably, the flat bed platen with the polishing pad or article adhered thereto is disposed vertically or parallel with gravitational force, and the polymeric foam article is adhered to the flat bed platen by vacuum.

In the rotation of the flat bed platen and any rotation of the grooving tool frame is supplied via a conventional drive mechanism strong enough to rotate the grooving tool frame and the flat bed platen, such as a gear box linked to a motor. Likewise, a conventional gear box may provide the needed drive mechanism for reciprocal rotation of the grooving tool frame relative to the flat bed platen all from the same motor.

The grooving tool frame and all of the cutting tool teeth can be formed from a single piece of material. For example, each tooth in a row of cutting tool teeth and its various parts can be ground from a solid block, such as a block of a metal nitride or carbide material.

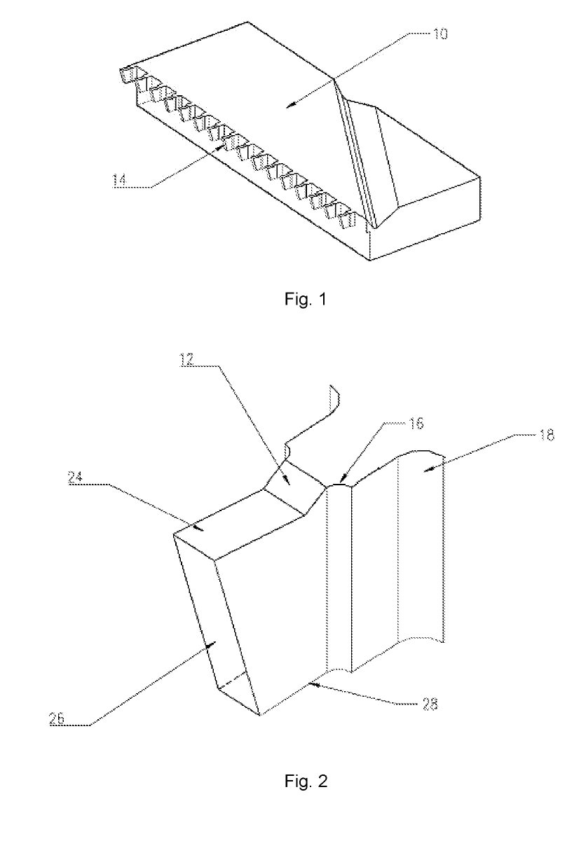

As shown in FIG. 1, a grooving tool frame (10) for machining concentric circular grooves into the flat surface of a polymeric foam article, such as polyurethane CMP polishing pads, includes multiple grooving teeth or cutting tool teeth (14) protruding from the front face of the grooving tool. In accordance with the present invention, the multiple teeth allow for numerous concentric grooves to be machined simultaneously. In machining, the flat surface of the polymeric foam article (not shown) rests on a rotating flat bed platen (not shown) and the flat surface of the polymeric foam article is positioned so that it lies parallel to the front face of the grooving tool frame (10); the grooving tool is moved into the flat surface of the polymeric foam article so that the cutting tool teeth (14) penetrate a desired depth into the flat surface of the polymeric foam article.

As shown in FIG. 2, a series of cutting tool teeth protrude from the front face of a grooving tool frame (10, FIG. 1). Each cutting tool tooth (14, FIG. 1) comprises a top groove cutting face (24) on its top side and extending to a chip ejection face (12) which forms an obtuse chip ejection angle with respect to the groove cutting face (24). The chip ejection face (12) provides for smooth evacuation of a chip of removed polymeric foam debris from the groove cutting face (24). Each chip ejection face has a width (W, not shown) and a front edge (not shown), which front edge may have any shape, for example, rounded or square. Each tool tooth (14, FIG. 1) has a shouldering radius (16), a transition from the final cutting tool tooth width to a larger non-cutting tooth shoulder width and provides added strength to the overall tooth and reduces tool vibration in use. Further, tool tooth protrusion radius (18) extending from the front face of the grooving tool frame (10, FIG. 1) to the shoulder area of the cutting tool tooth provides additional strength for the tool tooth tip. The cutting tool tooth further comprises a relief face (26) having a bottom relief angle defined by the plane of the top groove cutting face (24) and the plane of the relief face (26). The bottom relief angle eliminates much of the drag or friction caused by dragging the tool tooth bottom (28) through the groove channel formed during machining.

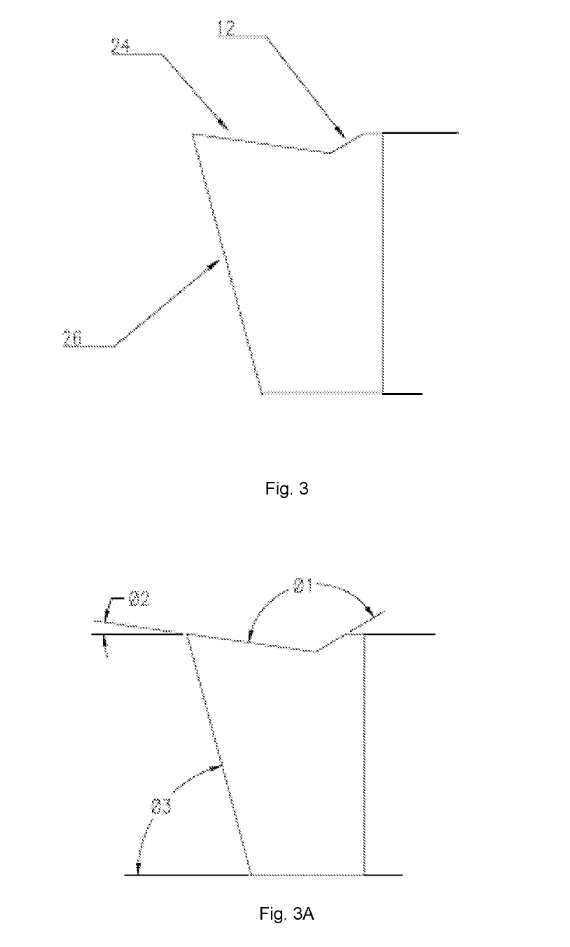

As shown in FIG. 3, a side profile of cutting tool tooth (14, FIG. 1) shows the ejection angle of the chip ejection face (12) or chip ejection angle that forms an obtuse angle with the groove cutting face (24) thereby enabling smooth evacuation of the polishing pad chip or debris from the groove cutting face. In addition, the cutting tool tooth (14, FIG. 1) has a side relief face (26) which tapers toward the grooving tool frame (10) from top to bottom whereby the cutting tool tooth does not scrape against the bottom of the groove formed by the cutting tool tooth.

As shown in FIG. 3a, a rake angle of the cutting tool tooth (14, FIG. 1) is the angle (Ø2) defined by the flat groove cutting face (24) and a line segment that is normal to the flat surface of the polymeric foam article in use of the grooving tool. For example, a conventional tool tooth having a zero rake angle would be positioned so that its top groove cutting face would lie perpendicular to the polymeric foam article substrate to be grooved. Further, chip ejection angle (Ø1) Is the angle defined by chip ejection face (12) and top groove cutting face (24). Further, bottom relief angle (Ø3) of the cutting tool tooth (14) is defined by the plane of the top groove cutting face (24, FIG. 3) and the plane of the relief face (26, FIG. 3).

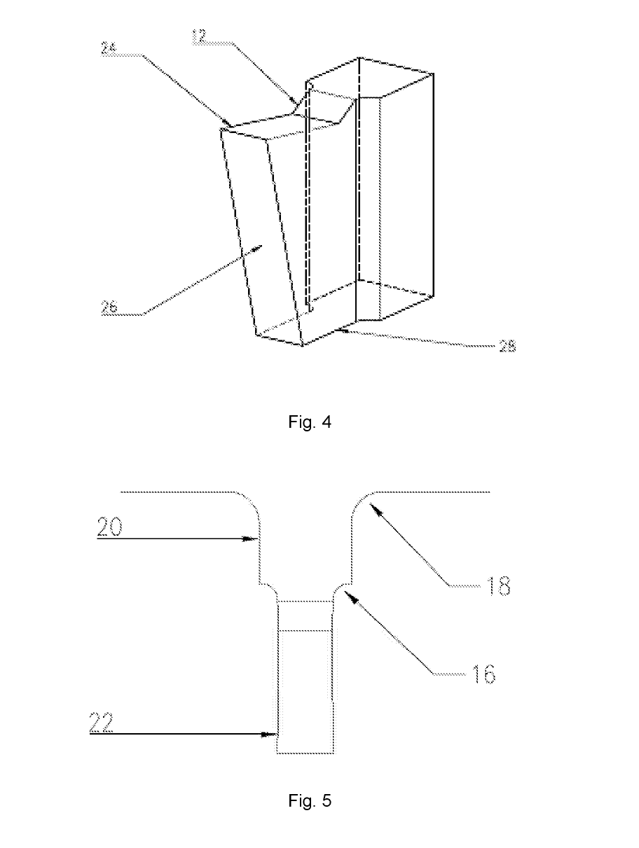

As shown in FIG. 4, the chip ejection face (12) of the cutting tool tooth (14, FIG. 1) forms an obtuse angle with respect to top groove cutting face (24). The top groove cutting face forms a rake angle (Ø2, FIG. 3a), thereby providing a sharper cutting tip and reduced stress input into the polymeric foam article to be grooved. A relief face (26) forms a groove cutting face bottom relief angle (Ø2, FIG. 3a). In addition, cutting tool tooth bottom (28) has a narrower width than the top groove cutting face (24) so as to limit friction that would otherwise be caused by the cutting tool tooth dragging against the sides of a groove during groove formation.

As shown in FIG. 5, each cutting tool tooth (14, FIG. 1) extends through a shouldering radius (16) to the grooving tool frame (10, FIG. 1) defining the transition from the cutting tool tooth width to the wider non-cutting shoulder (20) that provides a non-cutting shoulder surface that increases the strength of the cutting tool tooth by providing a wider base of juncture with the front face of the grooving tool frame (10, FIG. 1). The width (22) or W of the top groove cutting face (24, FIG. 4) of the cutting tool tooth (14, FIG. 1) remains constant and extends to the shouldering radius (16) such that the shoulder, which is not a cutting feature, never comes into direct contact with the polymeric foam article during machining.

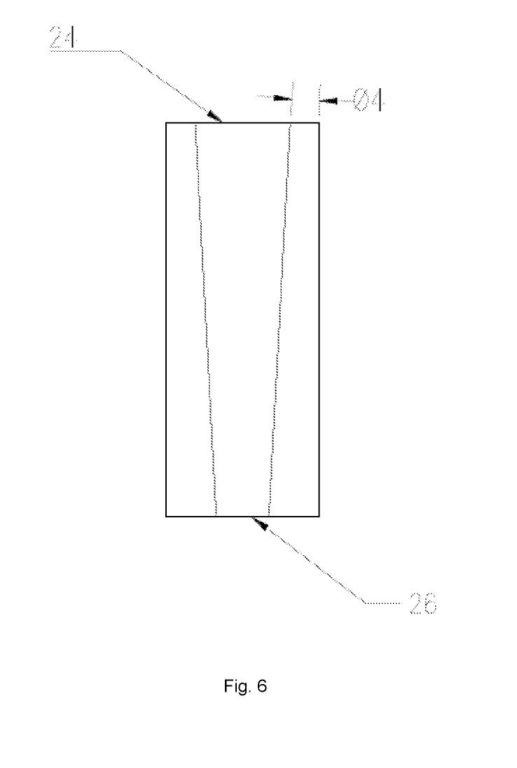

As shown in FIG. 6, a cutting tooth (14, FIG. 1) has on each side a side relief angle, e.g. of from 1° to 15° (Ø4), defined by the side faces of the cutting tool tooth (14, FIG. 1) and a line segment that runs normal to the groove cutting face (24) and starting at the side edge of the groove cutting face. In accordance with the side relief angle, the top groove cutting face (24) is slightly wider than the tool tooth bottom (28).

The side relief angle of the cutting tool tooth of the present invention eliminates excessive drag that would otherwise be caused by the dragging of the cutting tool tooth against the sides of a groove formed during machining. Preferably, the side relief angle is greater on the left hand side of the cutting tool tooth than it is on the right hand side, to allow for the approach of the groove wall on the left hand wall of the grooves in the pad as the cutting tool tooth passes along the groove.

In accordance with the present invention, methods of making grooved polymeric foam article having a flat surface, such as a polishing pads made of a polymeric foam, comprises (a) positioning a grooving tool frame so that the front face of the grooving tool faces the flat surface of a polymeric foam article or pad adhered to a flat bed platen, preferably, by vacuum, with each of the flat surface of the polymeric foam article or polishing pad and the flat bed platen having a center point so as to align each of the center points along an axis A that is perpendicular to the flat surface of the polymeric foam article or polishing pad (b) rotating the grooving tool frame and/or the flat bed platen relative to each other about the axis A so that the flat surface of the polymeric foam article or polishing pad strikes the groove cutting face of the one or more cutting tool teeth, preferably, rotating just the flat bed platen, while moving the grooving tool frame laterally toward the polymeric foam article or polishing pad surface, wherein the single axis extends normally though the center of the flat bed platen, the center of the polymeric foam article or polishing pad and the center of the radius of curvature of any path transcribed by the path of the grooving tool frame, so as to cut circumferential grooves into the flat surface of the polymeric foam article or polishing pad, such that radially inner most one of the circumferential grooves has a radius of curvature of 10 mm or smaller.

Preferably, the flat bed platen is rotated counterclockwise and the grooving tool is held stationary.

The method of the present invention preferably further comprises the steps of: (c) simultaneously cutting a multiplicity of circumferential, annular or concentric grooves into the flat surface of the polymeric foam article or polishing pad. This may be done so that, for example, the radially innermost one of the multiplicity of circumferential, or concentric annular grooves has a radius of curvature of 10 mm or smaller.

### EXAMPLES

The present invention will now be illustrated in detail in the following Examples. Unless otherwise stated, all units of temperature are room temperature (22-24° C.) and all units of pressure are standard pressure (101 kPa).

A CMP polishing pad was placed on a vertical flat bed platen and was rotated counterclockwise while a grooving tool frame equipped with cutting tool teeth was moved into the right hand side of the polishing pad, as one stands looking out from the flat bed platen.

In the inventive Examples that follow, each cutting tool tooth has, respectively, an 8° or 15° rake angle, 120° or 140° chip ejection angle, and a 50% or 1:2 cutting tool tooth width to non-cutting shoulder width ratio. The bottom face relief angle was set to 15° and the side relief angle was set at 2° for the right hand side of the tooth, and at 7° for the left hand side of the tooth.

In the comparative Examples that follow, each cutting tool tooth had a single width from tip to base and comprised a flat cutting groove cutting face and edge which was arranged perpendicularly to the pad surface.

### Example 1 and Comparative Example 1A

A total of 304 polyurethane foam CMP polishing pads with a nominal thickness of 0.2 mm and hardness shore D of 65 were produced for this trial. 16 tooth and 15 tooth count grooving tool frames were used to form the grooves. The data in this Example was compared against a total of 501 polyurethane foam pads produced using the conventional tool design. The conventional tool design was a 16 tooth grooving tool frame with an overall tooth length of 2.16 mm. The width of the conventional tool ranged from 0.47 mm to 0.48 mm.

The grooving tool used in this Example were manufactured from 48.8 mm wide carbide blanks. The cutting tool teeth ranged in width from 0.47 mm to 0.48 mm. The overall tooth length (Cutting face+non-cutting shouldering base) was set at 2.54 mm, with a minimum of 1.27 mm length from tooth tip held at the final groove cutting face width. The tooth shouldering base was 0.76 mm wide. The pitch between the cutting tool teeth was 3.0 mm. The cutting tool teeth were a square groove cutting edge design, producing square bottom shaped concentric grooves in the polyurethane pads. The depth target of grooves was set at 1.03 mm. The rake angle of the cutting tool teeth was set at 8°. The chip ejection angle used was 120°.

### Example 2 and Comparative Example 2A

A total of 102 polyurethane foam pads with a nominal thickness of 0.2 mm and hardness shore D of 65 were produced for this trial. A 16 tooth count grooving tool frame was used to process the Example pads. The data in this Example was compared against a total of 667 polyurethane foam pads produced using a conventional cutting tool tooth and process of record methods. The conventional tool design was a 16 tooth grooving tool frame with an overall tooth length of 1.27 mm. The width of the conventional tool ranged from 0.48 mm to 0.49 mm.

The cutting tool teeth used in this Example were manufactured from 48.8 mm carbide blanks. The cutting teeth ranged in width from 0.48 mm to 0.49 mm. The overall tooth length (Cutting face+non-cutting shouldering base) was set at 2.54 mm, with a minimum of 1.27 mm length from tooth tip held at the final groove cutting face width. The tooth non-cutting shoulder was 0.76 mm wide. The pitch between the cutting teeth was 3.0 mm. The teeth were a radius groove cutting edge design, producing round bottom shaped concentric grooves in polyurethane pads. The depth target of grooves was set at 1.03 mm. The rake angle of the cutting tool teeth was set at 8°. The chip ejection angle used was 120°.

### Example 3 and Comparative Example 3A

A total of 1248 polyurethane foam pads with a nominal thickness of 0.2 mm and hardness shore D of 65 were produced for this trial. A 27 tooth count grooving tool frame was used to process the Example pads. The data in this Example was compared against a total of 4220 polyurethane foam pads produced using a conventional cutting tool tooth design. The conventional tool design was a 27 tooth lathe insert with an overall tooth length of 2.0 mm. The width of the conventional tool ranged from 0.47 mm to 0.48 mm.

The cutting tool teeth used in this Example were manufactured from 48.8 mm carbide blanks. The cutting teeth ranged in width from 0.49 mm to 0.50 mm. The overall tooth length (Cutting face+non-cutting shouldering base) was set at 2.54 mm, with a minimum of 1.27 mm length from tooth tip held at final groove cutting face width. The non-cutting shoulder base was 0.76 mm wide. The pitch between the cutting tool teeth was 1.78 mm. The teeth were a radius groove cutting edge design, producing round bottom shaped concentric grooves in polyurethane pads. The depth target of grooves was set at 0.78 mm. The rake angle of the cutting tool teeth was set at 8°. The chip ejection angle used was 120°.

### Example 4 and Comparative Example 4A

Example 4 was conducted on 344 polyurethane foam pads with a nominal thickness of 2.0 mm and hardness shore D of 80. A 27 tooth grooving tool frame was used to process the Example pads. The data in this Example was compared against a total of 2136 polyurethane foam pads produced using a conventional tool design. The conventional tool design was a 27 tooth grooving tool frame with an overall groove cutting face length of 2.0 mm. The width of the conventional tool ranged from 0.51 mm 0.52 mm.

The cutting tool teeth used in this Example were manufactured from 48.8 mm carbide blanks. The cutting tool teeth ranged in width from 0.47 mm to 0.48 mm. The overall tooth length (Cutting face+non-cutting shouldering base) was set at 2.54 mm, with a minimum of 1.27 mm length from groove cutting edge held at final cutting tip width. The tooth non-cutting shoulder base was 0.76 mm wide. The pitch between the cutting tool teeth was 1.78 mm. The teeth were a square tip groove cutting edge design, producing square bottom shaped concentric grooves in polyurethane pads. The depth target of grooves was set at 0.78 mm. The rake angle of the cutting tool teeth was set at 8°. The chip ejection angle used was 120°.

### Example 5 and Comparative Example 5A

Example 5 was conducted on a total of 2797 polyurethane foam pads with a nominal thickness of 2.0 mm and hardness shore D of 65. A 16 tooth count grooving tool frame was used to process the Example pads. The data in this Example was compared against a total of 4753 polyurethane foam pads produced using the conventional tool designs. The conventional tool design was a 16 tooth grooving tool frame with an overall tooth length of 2.0 mm. The width of the conventional tool ranged from 0.47 mm to 0.48 mm.

The cutting tool teeth used in this Example were manufactured from 48.8 mm carbide blanks. The cutting tool teeth ranged in width from 0.47 mm to 0.48 mm. The overall tooth length (Cutting face+non-cutting shouldering base) was set at 2.54 mm, with a minimum of 1.27 mm length from tooth tip held at final cutting tip width. The tooth shouldering base was 0.76 mm wide. The pitch between the cutting teeth was 3.05 mm. The groove cutting edges were a square tip design, producing square bottom shaped concentric grooves in polyurethane pads. The depth target of grooves was set at 0.79 mm. The rake angle of the cutting tool teeth was set at 8°. The chip ejection angle used was 120°.

### Example 6 and Comparative Example 4A

Example 6 was conducted on 20 polyurethane foam pads with a nominal thickness of 2.0 mm and hardness Shore D of 80. A 27 tooth grooving tool frame was used to process the Example pads. The data in this Example was compared against a total of 2136 polyurethane foam pads produced using a conventional tool design. The conventional tool design was a 27 tooth grooving tool frame with an overall groove cutting face length of 2.0 mm. The width of the conventional tool ranged from 0.51 mm 0.52 mm.

The cutting tool teeth used in this Example were manufactured from 48.8 mm carbide blanks. The cutting tool teeth ranged in width from 0.47 mm to 0.48 mm. The overall tooth length (Cutting face+non-cutting shouldering base) was set at 2.54 mm, with a minimum of 1.27 mm length from groove cutting edge held at final cutting tip width. The tooth non-cutting shoulder base was 0.76 mm wide. The pitch between the cutting tool teeth was 1.78 mm. The teeth were a square tip groove cutting edge design, producing square bottom shaped concentric grooves in polyurethane pads. The depth target of grooves was set at 0.78 mm. The rake angle of the cutting tool teeth was set at 15°. The chip ejection angle used was 120°. Results are presented in Table 7, below.

Descriptions of the cutting tool teeth in Examples 1-5 and Comparative Examples 1A-5A are shown, respectively, in Table 1, below. Results from Examples 1-5 and Comparative Examples 1A-5A are shown in Tables 2 to 6, below.

TABLE 1
Cutting Tool Teeth

| | Tooth | Tooth | Groove | Tooth | |
|---|---|---|---|---|---|
| | cutting face | pitch | Target | cutting | Hardness |
| Example | width (μm) | (μm) | depth (μm) | edge shape | (Shore D) |
| 1 | 469.9 | 3048 | 1033.78 | Square end | 65 |
| 2 | 482.6 | 3048 | 779.78 | Round end | 65 |
| 3 | 490.22 | 1778 | 779.78 | Round end | 65 |
| 4 | 469.9 | 1778 | 779.78 | Square end | 80 |
| 5 | 469.9 | 3048 | 787.4 | Square end | 65 |
| 6 | 469.9 | 1778 | 779.78 | Square end | 80 |
| 1A* | 469.9 | 3048 | 1033.78 | Square end | 65 |
| 2A* | 482.6 | 3048 | 779.78 | Round end | 65 |
| 3A* | 490.22 | 1778 | 779.78 | Round end | 65 |
| 4A* | 469.9 | 1778 | 779.78 | Square end | 80 |
| 5A* | 469.9 | 3048 | 787.4 | Square end | 65 |

*Denotes Comparative Example

TABLE 2
Results From Examples 1 and 1A

Example

| Parameter | 1A* | 1 |
|---|---|---|
| Depth Range | 0.0016 | 0.0016 |
| Depth Range Std. Dev | 0.0004 | 0.0002 |
| Width Mean | 0.018 | 0.018 |
| Width Mean Std. Dev | 0.0007 | 0.0007 |
| Width Range | 0.0013 | 0.001 |
| Width Range Std. Dev | 0.0004 | 0.0001 |
| Yield | 92.61% | 99.01% |

*Denotes Comparative Example

TABLE 3
Results From Examples 2 and 2A

Example

| Parameter | 2A* | 2 |
|---|---|---|
| Depth Range | 0.0019 | 0.002 |
| Depth Range Std. Dev | 0.0006 | 0.0003 |
| Width Mean | 0.0187 | 0.0184 |
| Width Mean Std. Dev | 0.0009 | 0.0001 |
| Width Range | 0.0014 | 0.0013 |
| Width Range Std. Dev | 0.0006 | 0.0002 |
| Yield | 94.82% | 100.00% |

*Denotes Comparative Example

TABLE 4
Results From Examples 3 and 3A

Example

| Parameter | 3A* | 3 |
|---|---|---|
| Depth Range | 0.002 | 0.0022 |
| Depth Range Std. Dev | 0.0005 | 0.0009 |
| Width Mean | 0.0182 | 0.0182 |
| Width Mean Std. Dev | 0.0005 | 0.0003 |
| Width Range | 0.0017 | 0.0014 |
| Width Range Std. Dev | 0.0005 | 0.0004 |
| Yield | 97.27% | 99.04% |

*Denotes Comparative Example

TABLE 5
Results From Examples 4 and 4A

Example

| Parameter | 4A* | 4 |
|---|---|---|
| Depth Range | 0.0031 | 0.003 |
| Depth Range Std. Dev | 0.0007 | 0.0005 |
| Width Mean | 0.0194 | 0.0195 |
| Width Mean Std. Dev | 0.0004 | 0.0003 |
| Width Range | 0.0016 | 0.001 |
| Width Range Std. Dev | 0.0005 | 0.0001 |
| Yield | 97.75% | 99.13% |

*Denotes Comparative Example

TABLE 6
Results From Examples 5 and 5A

Example

| Parameter | 5A* | 5 |
|---|---|---|
| Depth Range | 0.002 | 0.0019 |
| Depth Range Std. Dev | 0.0006 | 0.0003 |
| Width Mean | 0.0185 | 0.0184 |
| Width Mean Std. Dev | 0.0006 | 0.0001 |
| Width Range | 0.0012 | 0.0011 |
| Width Range Std. Dev | 0.0013 | 0.0003 |
| Yield | 99.14% | 99.50% |

*Denotes Comparative Example

TABLE 7
Results From Examples 6 and 4A

Example

| Parameter | 4A* | 6 |
|---|---|---|
| Yield | 97.75% | 100.00% |

*Denotes Comparative Example

Grooving CMP polishing pads with the inventive cutting tool teeth of the present invention resulted in much lower variation in pad parameters and reduced inconsistent cutting performance and variations in groove shape. Further, the inventive cutting tool teeth reduced gelling defects by more than 50 percent. The results of all of the Examples 1 to 6 appear consistent regardless of groove shape, groove pitch or groove width. This suggests that the inventive chip ejection angle and the inventive rake angle determined the dimensional accuracy of the resulting grooves and the improved yield of the resulting CMP polishing pads.

As shown in Table 7, above, Comparative Example 4A gave a yield of 97.75%, and Example 6 gave a yield of 100.00%. Thus, the cutting tool tooth of the present invention with either an 8° or 15° rake angle eliminated gelling defects.

1. A grooving tool for machining the surface of a polymeric foam article having both a top and a bottom with a flat surface of a radius X, to form grooves therein, the grooving tool comprising:
a flat bed platen having a bed with a radius Y larger than radius X, the flat bed platen mounted rotatably on or to a static base about an axis A which is perpendicular to the bed and connected to a drive mechanism which rotates the flat bed platen; and,
a grooving tool frame mounted on an arm (a) connected to a drive mechanism which rotates the grooving tool frame about axis A reciprocally to the rotation of the flat bed platen or (b) mounted to a static base, the grooving tool frame having a front face positioned parallel to and facing the flat surface of the polymeric foam article on which front face is contained along an axis B which runs parallel to any radius X of the polymeric foam article one or more cutting tool teeth arranged in a predetermined direction and with a constant pitch so that the angle between each cutting tool tooth and the flat surface of the article or pad remains constant from tooth to tooth, wherein:
each cutting tool tooth has a non-cutting shoulder where it joins the grooving tool frame and has (i) a groove cutting face on the top of the tooth having a front edge, two side edges and a flat portion extending between the two side edges and having a constant width (W) and each cutting tool tooth is positioned so that the flat portion of the groove cutting face forms a rake angle with a line segment that is normal to the flat surface of the polymeric foam article or polishing pad, the rake angle ranging from 2° to 80°, (ii) a chip ejection face located on the top of the tooth between the non-cutting shoulder and the groove cutting face having a constant width (W) and forming an obtuse chip ejection angle ranging from 100° to 170° with the groove cutting face, (iii) a tool tooth bottom face; (iv) a shouldering radius transitioning from the cutting tool tooth to the non-cutting shoulder and extending from the top of the tooth at the chip ejection face to the tool tooth bottom face.

2. The grooving tool as claimed in claim 1, wherein the one or more cutting tool teeth are arranged so that the (i) groove cutting face would be normal to the flat surface of the polymeric foam article when subtracting the rake angle from the angle formed by the flat surface of the pad or article and the groove cutting face.

3. The grooving tool as claimed in claim 1, wherein in any cutting tool tooth the width ratio of the non-cutting shoulder to the cutting tool tooth ranges from 1.1:1 to 3:1.

4. The grooving tool as claimed in claim 1, wherein the (iii) tool tooth bottom face is narrower than the width (W) of the groove cutting face and the chip ejection face and the tool tooth has on each side a side face such that a side relief angle is formed by the plane of each side face and a line segment that runs normal to the groove cutting face starting at the side edge of the groove cutting face.

5. The grooving tool as claimed in claim 4, wherein the side faces of the cutting tool tooth form a side relief angle or taper, from the top to the bottom of the cutting tool tooth of from 1° to 15° on the left hand side of the tooth, and from 5 to 10° on right hand side of the tooth.

6. The grooving tool as claimed in claim 1, wherein the grooving tool frame further comprises for each cutting tool tooth a protrusion radius extending from the front face of the grooving tool frame to the non-cutting shoulder of the cutting tool tooth.

7. The grooving tool of the present invention as claimed in claim 1, wherein each of the one or more cutting tool teeth comprises (v) a relief face extending from the (i) front edge of the groove cutting face to the (iii) tool tooth bottom, thereby forming a bottom relief angle between the relief face and the groove cutting face and defined by the plane of the top groove cutting face and the plane of the relief face.

8. The grooving tool as claimed in claim 1, wherein each cutting tool tooth and non-cutting shoulder comprise a metal or semi-metal carbide.

9. The grooving tool as claimed in claim 1, wherein the grooving tool frame contains on its front face from 8 to 62 cutting tool teeth.

10. The grooving tool as claimed in claim 1, wherein each (i) cutting tool tooth is positioned so that the flat portion of the groove cutting face forms a rake angle with a line segment that is normal to the flat surface of the polymeric foam article or polishing pad, the rake angle ranging from 7° to 20°.
